(19) United States
(12) Patent Application Publication
(10) Pub. No.: US 2012/0263906 A1
(43) Pub. Date: Oct. 18, 2012

(54) COEXTRUSION DIE AND SYSTEM, METHOD OF MAKING COEXTRUDED ARTICLES AND COEXTRUDED ARTICLES MADE THEREBY

(75) Inventors: Ronald W. Ausen, Saint Paul, MN (US); William J. Kopecky, Hudson, WI (US); Danny L. Fleming, Stillwater, MN (US); David J. Yarusso, Shoreview, MN (US); Gibson L. Batch, Saint Paul, MN (US); Jeffrey O. Emslander, Stillwater, MN (US); James M. Jonza, Woodbury, MN (US)

(73) Assignee: 3M Innovative Properties Company, Saint Paul, MN (US)

(21) Appl. No.: 13/518,187

(22) PCT Filed: Dec. 15, 2010
(86) PCT No.: PCT/US10/60377

§ 371 Date: Jun. 21, 2012

Related U.S. Application Data
(60) Provisional application No. 61/290,626, filed on Dec. 29, 2009.

(51) Int. Cl. B29C 47/12; B32B 7/12; B32B 7/06; B29C 47/06

(52) U.S. Cl. 428/41.8; 425/131.1; 264/177.1; 428/343

(57) ABSTRACT

An extrusion die (20) and method for co-extruding a first molten polymeric material and a second molten polymeric material. The die includes a first die portion (20), a second die portion and a shim separating the first die portion and the second die portion. The shim has a first side and a second side, the first side of the shim forming a boundary of the first die portion and defining a first die cavity (38), the second side of the shim forming a boundary of the second die portion and defining a second die cavity (40). A dispensing edge (36) is provided having a plurality of first and second extrusion openings, a plurality of first feed channels connecting the first die cavity to the first extrusion openings along the dispensing edge, and a plurality of second feed channels connecting the second die cavity to the second extrusion openings along the dispensing edge. The first and second extrusion openings arranged along the dispensing edge to provide an interfacial zone having portions of the first extrusion openings disposed between portions of the second extrusion openings. The die is used in an extrusion system and a method for making a multilayered article.

The present invention relates to the art of extruding polymeric materials. In particular, the invention relates to coextruding polymeric materials into an article, and more particularly, to coextruding polymeric materials into a multilayered article having a structured interface between the extruded layers. The present invention also relates to an extrusion die for making such an article, to an extrusion system that includes the aforementioned die and to a method of making the aforementioned article by an extrusion process that uses the die.

### BACKGROUND

The coextrusion of multiple polymeric components into a single layer film is known in the art. Multiple polymeric flow streams have been combined in a die or feedblock in a layered fashion to provide a top to bottom multilayered film. It is also known to provide more complicated coextruded film structures where the film is partitioned, not as coextensive layers in the thickness direction but as stripes along the width dimension of the film. The art has referred to such a process as “side-by-side” coextrusion.

Improvements are needed in the art of coextruding multiple materials in a layered fashion, including improvements to extrusion devices and to extrusion processes for the manufacture of multilayered films and the like.

### SUMMARY

The present invention provides improvements in the art of coextrusion to simplify the manufacture of multilayered films and to provide a coextruded structured interface between the extruded layers.

In one aspect, the present invention provides an extrusion die for co-extruding a first molten polymeric material and a second molten polymeric material, the die comprising: a first die portion; a second die portion; and a shim separating the first die portion and the second die portion, the shim having a first side and a second side, the first side of the shim forming a boundary of the first die portion and defining a first die cavity, the second side of the shim forming a boundary of the second die portion and defining a second die cavity, a dispensing edge comprising a plurality of first and second extrusion openings, a plurality of first feed channels connecting the first die cavity to the first extrusion openings along the dispensing edge, and a plurality of second feed channels connecting the second die cavity to the second extrusion openings along the dispensing edge, the first and second extrusion openings arranged along the dispensing edge to provide: (a) an interfacial zone comprising portions of first extrusion openings disposed between portions of second extrusion openings, (b) a first continuous zone comprising portions of the first extrusion openings arranged in side-by-side relation to each other, and (c) a second continuous zone comprising portions of the second extrusion openings arranged in side-by-side relation to each other, wherein, the interfacial zone is disposed between the first continuous zone and the second continuous zone.

In another aspect, the invention provides an extrusion system for the manufacture of a multilayered film, the system comprising: The extrusion die as described above; a source of first molten polymeric material connected to the extrusion die to feed the first molten polymeric material into the first die cavity; a source of second molten polymeric material connected to the extrusion die to feed the second molten polymeric material into the second die cavity; cooling apparatus positioned to receive a multilayered molten sheet from the extrusion die, the multilayered molten sheet comprising the first and second molten polymeric materials, the cooling apparatus being at a temperature sufficient to at least partially solidify the multilayered molten sheet.

In still another aspect, the invention provides a method of producing an extruded article, the method comprising: providing an extrusion system as described above; feeding the first molten polymeric material from the source of first molten polymeric material into the first die cavity and through the plurality of first extrusion channels, the first molten polymeric material comprising a layer of pressure sensitive adhesive material having first and second major surfaces; extruding the second molten polymeric material from the source of second molten polymeric material through the second die cavity and through the second extrusion channels, the second molten polymeric material comprising a polymer release material having first and second major surfaces; the pressure sensitive adhesive material and the polymer release material exiting the extrusion die through the first and second extrusion openings along the dispensing edge of the die to provide a multilayered extrudate wherein the first major surface of the pressure sensitive adhesive overlays the first major surface of the polymer release material with a structured interface therebetween; and cooling the multilayered extrudate to provide the extruded article in the form of a pressure sensitive adhesive layer and a release liner removably affixed to the adhesive layer.

In still another aspect of the invention, an adhesive article is provided wherein the article comprises: an extruded pressure sensitive adhesive material layer having a first major surface and a second major surface, the first major surface having a microstructure provided by an extrusion die; an extruded release liner comprising a polymeric material layer having a first major surface and a second major surface, the first major surface of the release liner being releasably affixed to the second major surface of the pressure sensitive adhesive material and the first major surface of the release liner having a microstructure complimentary to the microstructure of the second major surface of the pressure sensitive adhesive material layer; wherein, the microstructure on the first major surface of the extruded release liner will retain its form when heated to the melting temperature of the first polymeric material.

The various terms used herein are to be construed as having their common meaning as understood by one of ordinary skill in the art. However, certain terms are expressly defined in order to clarify their meaning within the context of this disclosure.

As used herein, the term “structured interface” refers to the interface between layers of a coextruded material forming a multilayered film wherein the interface is non-planar. In other words, the contours that make up the interface are not all coplanar and often have significant non-planarity. Moreover, the structured interface may present a pattern with features that are measurable on a micro scale, in which case the structured interface may be referred to as a “microstructured” interface.

Terms such as “top”, “bottom”, “upper”, lower“, “under”, “over”, “front”, “back”, “outward”, “inward”, “up” and “down”, and/or “first” and “second” may be used in this disclosure. It will be understood that, unless otherwise noted, those terms are used in their relative sense only. In particular, in some embodiments certain components may be present in interchangeable and/or identical multiples (e.g., pairs). For these components, the designation of “first” and “second” may be applied to the components merely as a matter of convenience in the description of one or more of the embodiments.

The foregoing summary is not intended to describe each and every embodiment or every aspect of the present invention. Those of ordinary skill in the art will more fully understand the invention by considering the description that follows, including the detailed description together with the accompanying drawings and the appended claims.

### BRIEF DESCRIPTION OF THE DRAWINGS

In describing the embodiments of the invention, reference is made to the accompanying drawings which illustrate features that are further described herein. The described features are identified with reference numerals wherein similar reference numerals typically identify similar features. The drawings are provided to facilitate an understanding of the described embodiments and are not to be construed as being to scale. In the various drawings:

FIG. 1 is a perspective view of an extrusion die in accordance with one embodiment of the present invention;

FIG. 2 is a cross-sectional side view of the extrusion die of FIG. 1, taken along section lines 2-2 thereof;

FIG. 3 is a top plan view of a shim, shown in isolation, suitable for use in the extrusion die of FIG. 1;

FIG. 4 is an enlarged perspective view of the area “A” in FIG. 3;

FIG. 5 is a raised, enlarged, cross-sectional perspective view of the region “B” in FIG. 2;

FIGS. 6A, 6B and 6C are front plan views of different embodiments of a dispensing edge for a shim associated with an extrusion die, according the invention

FIG. 7 is a micrograph showing a cross-section of the extruded multilayered film of Example 1;

FIG. 8 is a micrograph showing a cross-section of the extruded film of Example 2;

FIG. 9 is a micrograph showing a cross-section of the extruded film of Example 3; and

FIG. 10 is a micrograph showing a cross-section of the extruded film of Example 4.

### DETAILED DESCRIPTION

The various embodiments of the invention include multizone extrusion dies, systems incorporating such dies, processes using the foregoing extrusion dies and extruded materials resulting from the foregoing processes. In various aspects, the invention facilitates the production or manufacture of multilayered extruded films wherein the interface between the extruded layers is a structured interface, and wherein the structured interface is imparted during the manufacturing process by the multizone extrusion die. In some embodiments, the interface between the layers of film is a microstructured interface.

In some embodiments, multilayered articles can be provided in the form of a layer of a pressure sensitive adhesive coextruded with a polymeric release liner, for example. Along a first major surface, the adhesive may be affixed to a support sheet having, for example, printed graphics on one surface of the support opposite that of the adhesive-coated surface. Along its second major surface, the adhesive is protected by the release liner, and the interface between the adhesive and the liner is microstructured. In the various embodiments, the structured or microstructured interface is created during coextrusion of the adhesive and the release liner. In such an embodiment, the release liner may be removed from the second major surface of the adhesive, and the thus exposed second major adhesive surface may be applied to another support surface (e.g., a wall, billboard, signage, etc.). The microstructured features of the adhesive surface provide air-bleed channels for the escape of air and to avoid the formation of air pockets between the adhesive and the support surface while the adhesive is being married to the display surface.

In some embodiments of the invention, an extrusion (or coextrusion) die is provided that is configured to coextrude more than one layer of material to form a multilayered sheet material or film having a structured interface between the aforementioned layers. As used herein, the term “coextrusion die” or “extrusion die” will be understood to include a die through which materials (as described herein) may be forced, pressed, pushed, shaped or otherwise directed through the die to provide the described product (e.g., a multilayered sheet material). In some embodiments, the materials may be supplied to the die using one or more extruders (e.g., single or twin screw). In other embodiments, the materials may be supplied through the die using, for example, a grid melter and a gear pump, or other sources of molten material (e.g., molten polymeric material).

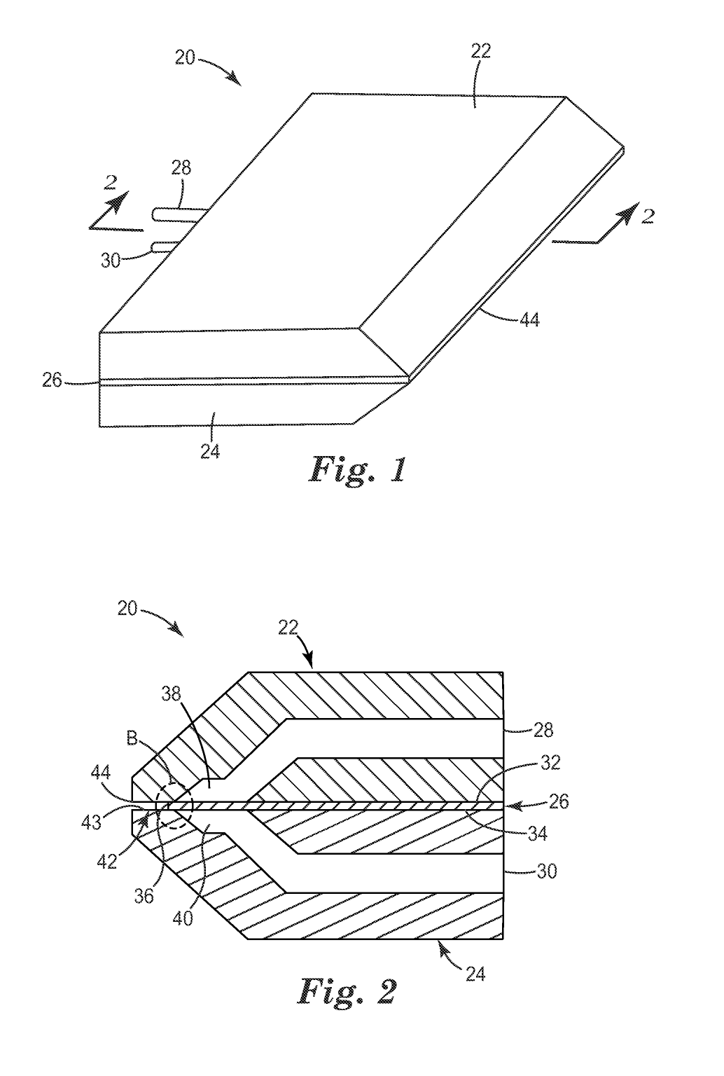

Referring to the Figures, FIG. 1 depicts a multizone extrusion die 20 in accordance with one embodiment of the invention. The die 20 includes a first die portion 22 and a second die portion 24, and a shim 26 disposed between the die portions 22 and 24. In some embodiments, the shim 26 is metallic. In other embodiments, the shim 26 is made of a ceramic material. The first die portion 22 provides a first zone within the die 20 and a first inlet 28 for receiving a supply of a first molten polymeric material and directing the material into the interior of first die portion 22. Second die portion 24 provides a second zone that includes a second inlet 30 for directing a supply of a second extrudable polymeric material into the interior of die portion 24. Both first material inlet 28 and second material inlet 30 are connected to separate sources of extrudable polymeric materials. The inlets 28 and 30 may be made from durable materials and may comprise melt pipes or heated hoses which, in turn, may be connected to pumps and screw extruders (e.g., twin screw and single screw extruders) or other sources of molten polymeric materials.

Referring to FIG. 2, an embodiment of shim 26 is shown which includes a first side 32 and a second side 34 and a leading or dispensing edge 36. The area designated “B” includes a portion of the dispensing edge 36, described below. Shim 26 is constructed to be positioned between the first die portion 22 and the second die portion 24. In this construction, first side 32 of shim 26 and first die portion 22 define a first die cavity 38 while second side 34 of shim 26 and second die portion 24 define a second die cavity 40. In the embodiment, first and second die portions 22 and 24 include a recessed area 42 in front of dispensing edge 36. Recessed area 42 extends inside the die 20 from the front surface 44 to the dispensing edge 36. Recessed area 42 includes land area 43.

The die cavities 38 and 40 on either side of shim 26 are configured to withstand being filled and pressurized with molten polymeric material. It will be appreciated that the pressure exerted by molten polymeric material will depend on several factors. However, the pressure differential between cavities 38 and 40 should not exceed the physical distortion strength of the shim 26. In some embodiments, metal shims having thicknesses between about 1 mm and about 2 mm have been strong enough to withstand normal operating pressures. In some embodiments, a thickness of about 1.5 mm is appropriate. Moreover, it will be appreciated that the viscosity of one or both of the polymeric materials may also be manipulated in a known manner as may be needed to assist in controlling the pressure differential between die cavities 38 and 40.

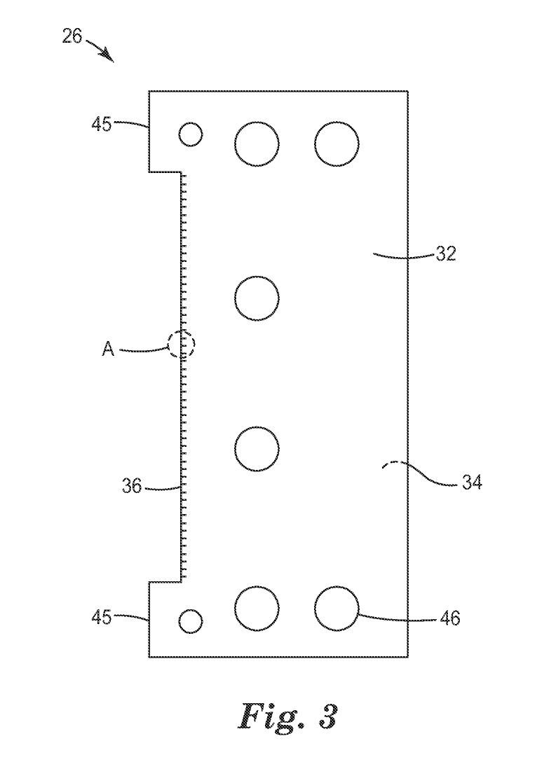

Referring to FIG. 3, a top plan view of shim 26 is shown and will now be described. In the depicted embodiment, dispensing edge 36 is depicted in an optional configuration in which the edge 36 is recessed back from the front edge 45 of the shim to facilitate having the edge 36 offset from the front 44 of die 20, as previously described. It will be appreciated that the recessed feature of dispensing edge 36 is optional. While such a feature may be desired in some embodiments, like that depicted in FIGS. 2 and 3, other embodiments of the invention do not require this feature. Through holes 46 may be provided as needed to receive machine bolts or the like therethrough when fastening the components of the die 20 together as an assembly. Through holes 46 may be preformed during the manufacture of the shim 26, or they may subsequently be drilled at the time the die 20 is assembled.

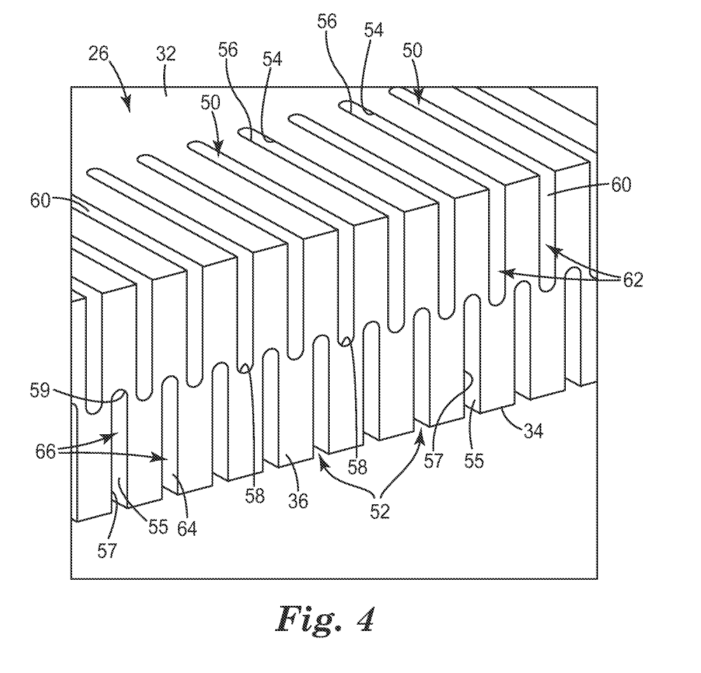

Referring now to FIG. 4, a detailed perspective view is provided of the area “A” of FIG. 3 to illustrate one embodiment of the extrusion edge 36. Sufficient extrusion channels are provided to accommodate more than one molten polymeric material. In the depicted embodiment, two sets of inlet grooves are provided within the dispensing edge 36 of the shim 26. Specifically, first grooves 50 are provided in first side 32 of shim 26. In the assembled die 20 (see, e.g., FIG. 1), first grooves 50 provide the openings for molten polymeric material to travel from first die cavity 38 into first feed channels 60 extending from the first cavity 38 (see FIG. 2) to the dispensing edge 36. Likewise, second grooves 52 are provided in the second side 34 of shim 26 and provide a plurality of openings for molten polymeric material to flow from the second die cavity 40 into second feed channels 64 extending from the die cavity 40 to dispensing edge 36. First feed channels 60 include side walls 54 and 56 with a joining surface 58 connecting the side walls to one another. Likewise, second feed channels 64 includes side walls 55 and 57 with a joining surface 59 connecting the side walls to one another. In some embodiments, the joining surface of each of the feed channels and openings slope at an angle, typically an acute angle, toward the dispensing edge 36.

First grooves 50 extend from the upper or top side of the shim 26 forming a plurality of first feed channels 60 which terminate along the dispensing edge 36 at first openings 62. Second grooves 52 extend from the lower or bottom side of the shim 26 forming a plurality of second feed channels 64 connected to second openings 66 along the dispensing edge 36. The first grooves 50 and first feed channels 60 are disposed so that each first feed channel 60 is disposed between adjacent second feed channels 64, and vice versa. Similarly, first openings 62 alternate in frequency with second openings 66 along the length of dispensing edge 36.

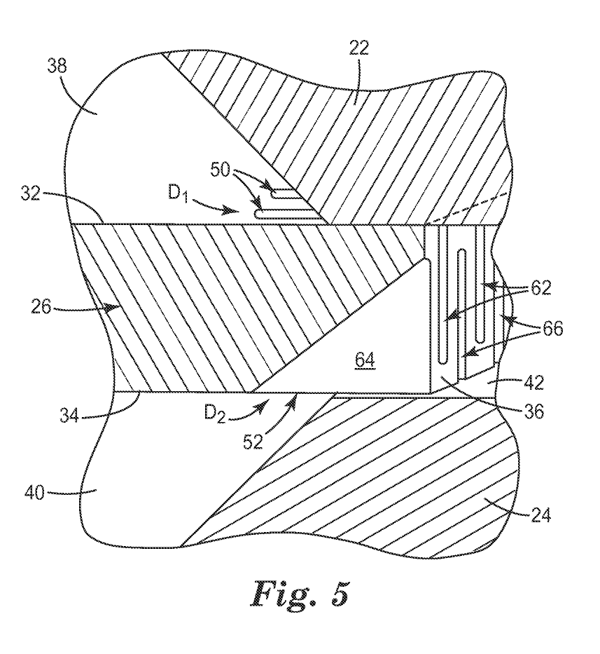

Referring to FIG. 5, a partial view of shim 26 is shown, in cross section, retained between first die portion 22 and second die portion 24. Shim 26 is retained between die portions 22 and 24 so as to form a seal around the dispensing edge 36 to prevent intermixing of molten polymeric materials flowing through die cavities 38 and 40 before the molten materials are dispensed from openings 62 and 66 along dispensing edge 36. During an extrusion operation using the die 20, a first molten polymeric material is disposed in first die cavity 38. Under pressure, the material is forced or pushed in direction D1 through the first cavity to first grooves 50. The first molten polymeric material moves through the grooves 50 into the first feed channels 60 and ultimately through first openings 62 along the dispensing edge 36. Similarly, molten second polymeric material is moved into the second cavity 40. Under pressure, the second material is moved in direction D2 through the second cavity to second grooves 52. The second molten polymeric material moves through the grooves 52 into the second feed channels 64 and ultimately through second openings 66 along the dispensing edge 36.

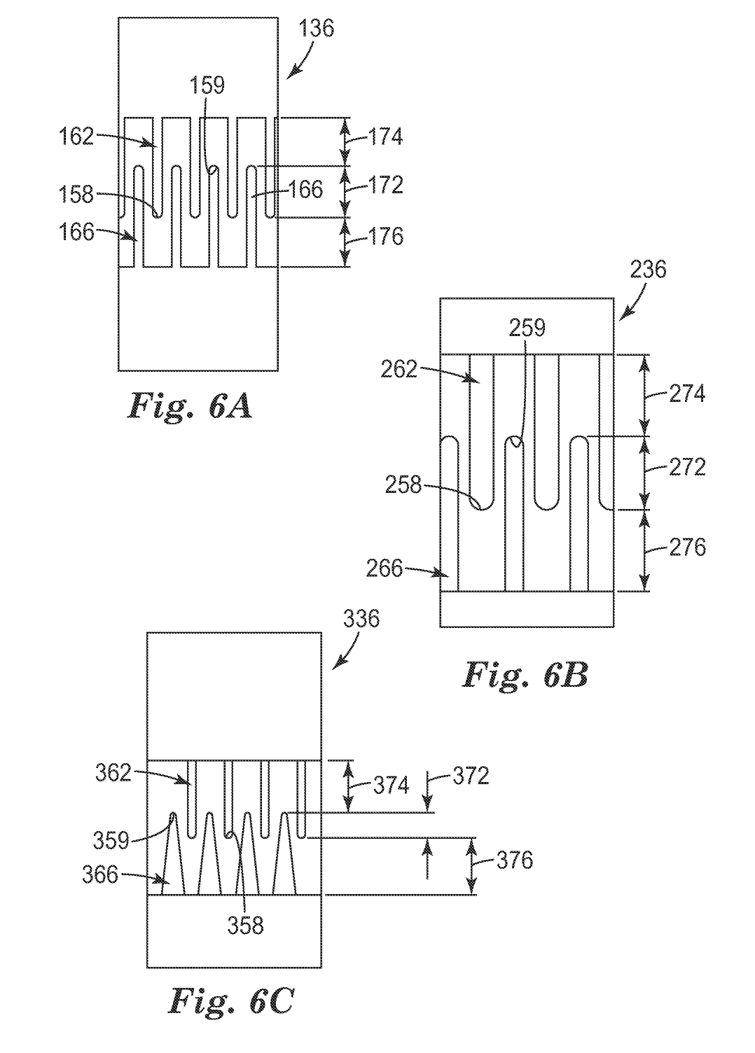

Referring to FIG. 6, alternate configurations are depicted for the dispensing edge of shim 26. FIG. 6A is a front view of a portion of one embodiment for configuring the dispensing edge of the shim 26. As can be seen, dispensing edge 136 is similar to edge 36 of FIG. 4. In the embodiment of FIG. 6A, first openings 162 and second openings 166 are substantially parallel to one another, and each first opening 162 extends downwardly and terminates at an edge 158 while each second opening 166 extends upwardly, as depicted, and terminates at an edge 159. First and second openings 162 and 166 extend slightly past one another so that each of the openings can be characterized as partially overlapping, with the overlapping portions of the openings falling within an “interfacial zone,” designated in the Figure as the area 172. The remaining portions of first and second openings 162 and 166 are outside of the interfacial zone 172 with the non-overlapping portions of first openings 162 forming a first continuous zone 174 and the non-overlapping portions of second openings 166 forming a second continuous zone 176. During an extrusion operation, first and second molten polymeric materials are forced through the openings 162 and 166 as molten “fingers” of material. These fingers of molten material will expand or swell in a known manner upon exiting openings 162 and 166 along the dispensing edge 136. The portions of materials extruded though the openings 162 and 166 within the interfacial zone 172 will result in an overlapping structure comprised of portions of first molten polymeric material disposed between portions of the second molten polymeric material. The portions of materials extruded though the openings 162 and 166 outside of the interfacial zone and in the first continuous zone 174 and second continuous zone 176 will result in continuous areas of first material and continuous areas of second material on either side of the interfacial structure. The resulting product is a two layered sheet of first material and second material overlying one another and sharing a common structured interface. As described, the structured interface is the result of the portions of first and second materials that pass through interfacial zone 172.

Referring to FIG. 6B, another embodiment of a dispensing edge 236 for inclusion in shim 26 is shown. First openings 262 and second openings 266 are substantially parallel to one another but have unequal widths (e.g., their corresponding side walls are not spaced apart the same distance). Each first opening 262 extends downwardly and terminates at edge 258 while each second opening 266 extends upwardly and terminates at edge 259. First and second openings 262 and 266 extend slightly past one another so that each of the overlapping portions of openings 262 and 266 can be characterized as falling within an “interfacial zone,” designated as the area 272. The portions of materials extruded though the openings 262 and 266 outside of the interfacial zone in the first continuous zone 274 and/or the second continuous zone 276 result in continuous areas of first material and continuous areas of second material, respectively, on either side of the structured interface. The resulting product is a two layered sheet of first material and second material overlying one another and sharing a common structured interface. As described, the structured interface is the result of the portions of first and second materials that pass through interfacial zone 272.

Referring to FIG. 6C, still another embodiment of a dispensing edge 336 suitable for use in shim 26 is shown. First openings 362 are provided with side walls that are perpendicular to the corresponding side of the shim 26 from which they are cut. Second openings 366 have been cut so as to form side walls that taper at a non-right angle to the corresponding side of the shim 26. Each first opening 362 extends downwardly, as shown in the Figure, and terminates at edge 358 while each second opening 366 extends upwardly, as depicted, and terminates at edge 359. First and second openings 362 and 366 extend slightly past one another so that each of the overlapping portions of openings 362 and 366 can be characterized as falling within an “interfacial zone” 372. The portions of materials extruded though the openings 362 and 366 outside of the interfacial zone and in the first continuous zone 374 and second continuous zone 376 will result in continuous areas of first material and continuous areas of second material on either side of the structured interface. The resulting product is a two layered sheet of first material and second material overlying one another and sharing a common structured interface. As described, the structured interface is the result of the portions of first and second materials that pass through interfacial zone 372.

As shown in the embodiments of FIGS. 6A-6C, the profiles of the first and second openings along the dispensing edge and their corresponding feed channels can be provided with identical configurations or they may be configured differently. The side walls of the first and second feed channels can be parallel to each other, or they can be angled (e.g., an acute, right or obtuse angle) with respect to each other. In addition, the side walls of the first feed channels can be perpendicular or they can be oriented at an angle (other than a right angle) with respect to the first side of the shim, or the side walls of the first channels can be formed so as to taper outwardly from the joining surfaces to the first side and the dispensing edge of the shim (i.e., the distance between the side walls adjacent the joining surface can be smaller than the distance between the side walls either adjacent the first side of the shim, adjacent the dispensing edge, or both). Likewise, the side walls of the second channels can be perpendicular or they can be oriented at an angle (other than a right angle) with respect to the second side of the shim, or the side walls of the second channels can be formed so as to taper out from their joining surfaces to the second side and the dispensing edge of the shim (i.e., the distance between the side walls adjacent the joining surface can be smaller than the distance between the side walls either adjacent the second side of the shim, adjacent the dispensing edge, or both).

The side walls of both sets of feed channels can be perpendicular to or they can taper out to their corresponding side of the shim and the dispensing edge, or one set of channels can be perpendicular and the other set tapered. The depths of the first and second feed channels can also be similar or different. The use of slanted feed channels will create slanted zones, relative to the plane of the extrudate (e.g., a film).

Depending on the desired configuration of the structured interface in the multilayered extrudate, it is typically desirable for the first openings of the first feed channels to extend from a first side of the shim part way (e.g., not all the way) toward the second side of the shim. Similarly, the second openings of the second feed channels ought to extend from the second side of the shim part way toward the first side of the shim. In such a construction, the dispensing edge of the shim is provided with an interfacial zone for the creation of a structured interface, as previously described. The degree of overlap between the first and second openings can be varied somewhat, and the configurations, dimensions and orientation of the openings may be varied in order to provide the structured interface suitable for a particular article. The present invention allows for the use of relatively narrow exit openings. For example, each exit opening of either the first or second channels can have a maximum width dimension (i.e., the maximum distance between opposite side walls of the channel at the exit opening) of less than or equal to about 1.5 mm (1500 micrometers). Larger channel width dimensions can also be used in accordance with the various embodiments of the present invention. The resistance to flowing a polymeric material through a channel can increase as the reciprocal of the third power of the channel width. This resistance can limit, as a practical matter, the effective minimum dimensions of the channels. As a result, each of the channels may have a minimum width dimension (i.e., the minimum distance between opposite side walls of the channel at the exit opening) of about 50 micrometers, or possibly as low as about 25 micrometers. It may be possible to extrude with even smaller channel width dimensions by using heat or radiation curable polymeric materials, since such materials typically have relatively lower viscosities than thermoplastic extrudable polymeric materials. In some embodiments, the dispensing edge may be provided as a non-planar surface. In some embodiments, the dispensing edge is chamfered at one or both of its edges to assist in the formation of a continuous layer of one or both of the first and second molten polymeric materials.

In each of the embodiments of the dispensing edges illustrated in FIGS. 6A to 6C, each of the dispensing edges are affixed to a shim which, in use, serves to separate two molten polymeric materials during the extrusion process as the materials travel through the chambers of the die 20 and to the dispensing edge 36. The foregoing embodiments are not to be construed as limiting but are representative of the degree to which the first and second exit openings overlap each other in order to provide a structured interface between the layers of extruded materials. The particular configuration of the structured or microstructured interface can depend on a variety of factors including the degree of overlap between the first and second openings (e.g., the relative size of the interfacial zone on the die face), the configuration or shapes of the exit openings on the dispensing edge and the properties of the materials being extruded, for example.

The foregoing embodiments of a die may be manufactured in a known manner, With regard to the manufacture of a dispensing edge for an extrusion shim (e.g., shim 26 in FIG. 3), the grooves, feed channels and exit openings may be made using, for example, wire electrical discharge machining (EDM) or other methods of machining techniques such as laser, e-beam, or diamond machining

In the use of the foregoing die, any of a variety of extrudable polymeric materials can be used. In addition to conventional extrudable thermoplastic polymeric materials, the present invention may also be used to coextrude polymeric materials that can be crosslinked. For example, either or both of the first and second extrudable polymeric materials may comprise curable resin. When a heat curable resin is used, the die 20 can be heated to initiate the curing process as well as to adjust the viscosity of the polymeric material and/or the pressure in the corresponding die cavities (e.g., cavities 38 and 40).

In embodiments of the invention, a system for the manufacture of multilayered sheets is provided that includes sources of the first and second molten polymeric materials to provide the polymeric materials to the extrusion die. In some embodiments, sources of the first and second molten polymeric materials are first and second extruders which are equipped to process different polymer materials. Both extruders are connected to the above described die 20 so that the first extruder provides a first molten polymeric material to the first die zone or cavity 38 and second extruder provides a second molten polymeric material to the second die zone or die cavity 40. The operation and configuration of such a system will be known to those of ordinary skill in the art. Suitable extruders will be capable of processing polymeric and monomeric materials as well as additives, solvents and the like in order to provide first and second molten polymeric materials that may be processed through the die 20 as previously described. Either or both of the extruders may comprise a plurality of heated zones as well as a hopper to direct components of the polymeric materials into the extruders in a known manner. In various embodiments, either single screw extruders or twin screw extruders may be used.

In the aforementioned system, die 20 is positioned to receive feeds of molten polymeric materials coming from both extruders and to maintain the feeds as separate streams, each stream passing through one of the die cavities 38 and 40 and into the dispensing edge 36 and feed channels 60 and 64, as previously described. The two molten polymeric materials are extruded through the multizone die 20 in two streams which adhere to one another to from a multilayered sheet having two distinct layers, each layer formed by one of the molten polymeric materials. As mentioned, the interface between the layers is structured as a direct result of the configuration of the openings (e.g., openings 62 and 66) and the degree to which the openings overlap one another within the interfacial zone (e.g., zone 172, FIG. 6A). It will be appreciated that other embodiments, the system can includes other means for the delivery of molten polymeric materials to the extrusion die. In some embodiments, one or more grid melters and pumps will deliver molten polymeric materials to the extrusion die 20. In some embodiments, a single extruder may supply one of the molten materials to the die while another means (e.g., a grid melter and pump) may be used for the delivery of the other molten material. It will be understood that the inclusion of single or double screw extruders as an initial source of material is a matter of design choice depending on the materials being used and other criteria familiar to those of ordinary skill in the art.

The extruded multilayered sheet is cooled upon exiting the die 20, and the sheet material may then be further processed or, for example, wound up onto a roll for storage or further processing at a later time. Cooling of the material may be accomplished on a chill roll or the like positioned to receive the multilayered extrudate as it exits the die. In other embodiments, the molten material is cooled on a series of cooling rolls or in a water bath, for example.

In some embodiments, the molten polymeric materials are a polymer-containing adhesive, such as a pressure sensitive adhesive, and a release liner. In embodiments of the invention that comprise the coextrusion of a pressure sensitive adhesive and a release liner, any of a variety of suitable adhesive compositions may be used including without limitation those based on rubbers, thermoplastic elastomers, polyvinyl ethers, poly-alpha-olefins, polyacrylates and/or methacrylates, silicones and the like.

In some embodiments, the pressure adhesive is an acrylate adhesive formed by reaction of one or more acrylate or methacrylate monomer(s) and acrylic acid. In one embodiment, the acrylate adhesive comprises a polymer that is the reaction product of acrylic acid and 2-ethylhexyl acrylate. Suitable monomers can be selected from the group acrylic acid, butyl acrylate, 2-ethylhexyl acrylate, isooctyl acrylate, isononyl acrylate, n-butyl acrylate, 2-methyl-butyl acrylate, methyl acrylate, ethyl acrylate, acrylonitrile, methyl methacrylate, trimethylolpropane triacrylate (TMPTA), vinyl acetate, N-vinyl pyrrolidone, methacrylamide, and combinations of two or more of the foregoing. In other embodiments, the adhesive is a block copolymer such as, for example, styrene-isoprene block copolymer or an ethylene/methacrylic acid. The combination of block copolymers may include di-block, tri-block, tetra-block and higher order (so called star-block) copolymers.

In addition to the described embodiments of base adhesive resin, those of ordinary skill in the art will appreciate that tackifying resins and other additives may be added to the adhesive formulation to adjust initial tack, adhesive strength, performance over a desired temperature range, dispensability or durability. Some examples of tackifiers include rosin ester resins, aromatic hydrocarbon resins, aliphatic hydrocarbon resins, and terpene resins. Oils, plasticizers, fillers, antioxidants, ultraviolet stabilizers, flame retardants and curing agents are examples of other classes of additives.

Release liners may be made from known materials suitable for such an application such as, for example, plastic materials such as polyolefins and, more specifically, polypropylene, polyethylene. Suitable polyethylene may be a high density polyethylene (HDPE), a low density polyethylene (LDPE), an ultra-low density polyethylene, or random or block copolymers of ethylene, propylene, butane, hexane and/or octene. Suitable polypropylenes include homopolymers and copolymers with ethylene, butane, hexane, and/or octene,

Another suitable class of release materials are fluoropolymers such as homopolymers and copolymers chosen from vinyl fluoride, vinylidene fluoride, trifluoroethylene, tetrafluoroethylene, chlorotrifluoroethylene, hexafluoropropylene, perfluoromethyl vinyl ether, combinations of the foregoing and possibly also containing ethylene, propylene, butane, hexane, octene, or minor amounts of other vinyl monomers.

Yet another suitable class of release materials are silicones. These materials contain —O—Si— backbones. Side groups may include methyl, ethyl and longer alkyl, fluoroalkyl, phenyl or vinyl moieties. Additionally, silicone block copolymers may also be useful.

In embodiment, the inventions provides a pressure sensitive adhesive and a release liner wherein the coextrusion process of the invention provides a structured interface in which the release layer retains a structured or microstructured configuration at its normal melting point. Consequently, coextrusion enables a temperature tolerance for the release layer that is not witnessed in an embossing process, for example. Moreover, coextrusion avoids the need for additional steps in the manufacture of an adhesive article as described herein and, with the manufacture of an appropriate die, provides a relatively fast and inexpensive manufacturing process for structured or microstructured pressure sensitive adhesive articles with a release liners. In some embodiments, the foregoing embodiments of the invention are especially useful in the manufacture of acrylate adhesives and polyethylene release liners wherein the structured surface is a microstructured surface that provides air bleed channels for the escape of air while the pressure sensitive adhesive is married with a display surface or the like.

Additionally, any of the foregoing adhesive materials and/or the release liner materials may be further reinforced with another support layer, as known by those of ordinary skill in the art. Suitable materials for supporting the adhesive may be selected from any of a variety of sheet materials such as woven materials, non-woven materials, polymeric sheets, man-made and natural fabrics, paper, or the like. In some embodiments, the support is a sheet material that is capable of receiving printed letters and images on the major surface of the adhesive opposite the structured interface. In some embodiments, the adhesive layer is a pressure sensitive adhesive, and the support for the adhesive includes printed words or images on the major surface of the support opposite the structured interface. In such a construction, with the release layer removed, the structured surface of the adhesive is exposed and may be applied to a suitable display surface (e.g., a wall, billboard or the like). In the application of the adhesive to a display surface, the structured surface of the adhesive provides air bleed channels which provide a pathway for air to escape while the adhesive is being married to the display surface. In such a construction, the entrapment of air bubbles or air pockets between the adhesive and the display surface is avoided, and the printed words or images on the non-adhesive side of the support can be displayed and viewed as originally intended, i.e., on a smooth flat surface. Application of a support layer to the adhesive or to the liner may be made in a continuous or in a non-continuous manner. Suitable support materials for the release liner include paper, other polymer materials, fabrics, woven materials, nonwoven materials and the like.

In addition to graphical displays comprising the foregoing pressure sensitive adhesive and release liner, embodiments of the invention may be used in the preparation of other multilayered sheet-like constructions such as drag reduction films applied to airplanes, boats, automobiles, wind or water turbines. Abrasion resistant films for wind turbine blades, automobiles and other vehicles as well as rollgoods, flooring and roofing products may also be prepared according to one or more embodiments of the invention.

### EXAMPLES

Specific detailed embodiments are further provided in the following non-limiting Examples.

### Shim Preparation:

A shim similar to that shown in FIG. 3 was manufactured from 1.5 mm thick stainless steel metal shim stock. Two sets of grooves, feed channels (micro-channels) and openings were machined into the dispensing edge of the shim using conventional wire electron discharge machining (EDM) techniques. The first set of feed channels, in the upper/top side of the shim, had a length of 1600 microns measured in the direction of polymer flow and a width of 87.5 microns with openings extending 1050 microns across the width of the dispensing edge of the shim. The second set of feed channels, in the lower/bottom side of the shim, had a length of 1600 microns measured in the direction of polymer flow and a width of 125 microns and included openings that extended 825 microns across the width of the dispensing edge of the shim. The first set of openings alternated with the second set of openings across the dispensing edge of the shim with a spacing of 70 microns between each opening, and each of the feed channels and openings were separated from adjacent channels and openings by a foil barrier. The shim was used in an extrusion die by positioning the shim between two die halves with a sealing surface that extended back from the dispensing edge of the shim by a distance of about 1000 microns

### Example 1

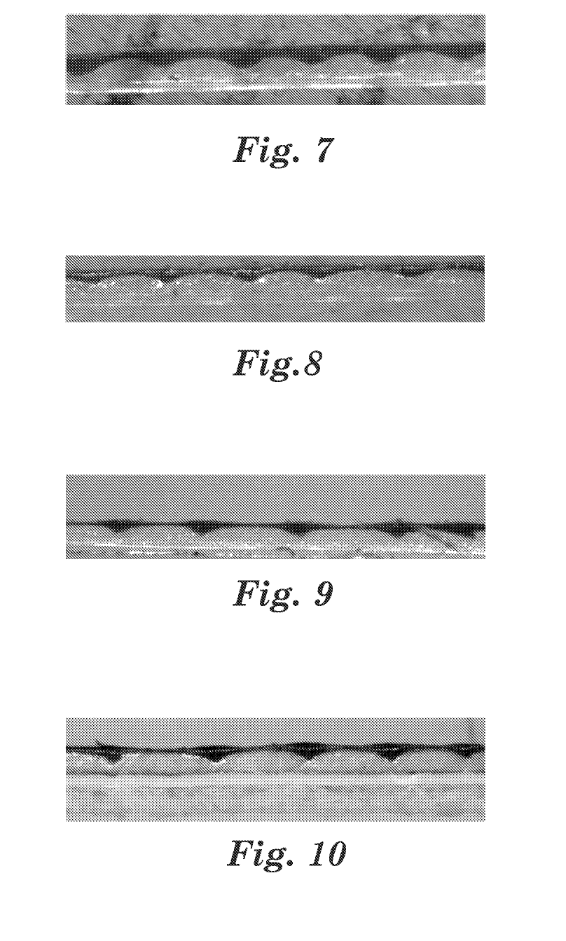

A coextruded film was prepared using the shim described above and the following procedure. A 32-mm single screw extruder (3:1 L/D, water-cooled feed throat) was used to melt and extrude a low density polyethylene (INFUSE D9807, 15 MI, from Dow Chemical Co., Midland, Mich.) into a first manifold of a dual-manifold extrusion die. The polyethylene was pigmented blue using 2% by weight of a blue color concentrate. A flow rate of 1.2 kg/hr was used. The melt temperature was maintained at 190° C. A second 32-mm single screw extruder (3:1 L/D, water-cooled feed throat) was used to melt and extrude an acrylate adhesive into a second manifold of a dual-manifold extrusion die. The acrylate adhesive consisted of a pre-polymerized blend of 87.5% by weight ethyl hexyl acrylate and 12.5% acrylic acid. The adhesive was melted in a Bonnot adhesive pump set at 175° C. (Bonnot Model 2WPKR, 50 mm, from Bonnot Manufacturing, Green, Ohio) and then injected into the extruder just after the feed throat. A flow rate of 2.1 kg/hr was used. The melt temperature was maintained at 190° C. The extrudates from the extruders were fed to a dual-manifold die maintained at 204° C. and fitted with the shim described above. The polyethylene was used to feed the first manifold of the die which supplied material to the first set of grooves in the upper/top side of the shim. The acrylate adhesive was used to feed the second manifold of the die which supplied material to the second set of grooves in the lower/bottom side of the shim. After exiting the dispensing edge of the shim, the combined extrudate flowed 12.5 mm through the land region of the die and then were deposited vertically downward onto a 50 micron polyethylene terephthalate (PET) film and then cooled on a temperature-controlled chrome finish steel roll (20° C.) at a line speed of 3.1 meter/minute. A photomicrograph of a cross-section of the film is shown in FIG. 7 with the darker portions in the photomicrograph corresponding to the polyethylene.

### Example 2

A coextruded film was prepared as in Example 1 except the flow rate of the polyethylene was 0.9 kg/hr. A photomicrograph of a cross-section of the film is shown in FIG. 8 with the darker portions in the photomicrograph corresponding to the polyethylene.

### Example 3

A coextruded film was prepared as in Example 2 except INFUSE D9507 (5 MI, available from Dow Chemical Co., Midland, Mich.) was used for the polyethylene layer. A photomicrograph of a cross-section of the film is shown in FIG. 9 with the darker portions in the photomicrograph corresponding to the polyethylene.

### Example 4

A coextruded film was prepared as in Example 2 except that the extrudate was deposited onto a PVC (vinyl) cast film in place of the PET film. A photomicrograph of a cross-section of the film is shown in FIG. 10 with the darker portions in the photomicrograph corresponding to the polyethylene.

Embodiments of the invention have been discussed and described herein. The described embodiments are potentially amenable to various modifications and alterations by those of ordinary skill in the art without departing from the spirit and the scope of the invention.

1. An extrusion die for co-extruding a first molten polymeric material and a second molten polymeric material, the die comprising:
a first die portion;
a second die portion; and
a shim separating the first die portion and the second die portion, the shim having a first side and a second side, the first side of the shim forming a boundary of the first die portion and defining a first die cavity, the second side of the shim forming a boundary of the second die portion and defining a second die cavity, a dispensing edge comprising a plurality of first and second extrusion openings, a plurality of first feed channels connecting the first die cavity to the first extrusion openings along the dispensing edge, and a plurality of second feed channels connecting the second die cavity to the second extrusion openings along the dispensing edge, the first and second extrusion openings arranged along the dispensing edge to provide:
(a) an interfacial zone comprising portions of first extrusion openings disposed between portions of second extrusion openings,
(b) a first continuous zone comprising portions of the first extrusion openings arranged in side-by-side relation to each other, and
(c) a second continuous zone comprising portions of the second extrusion openings arranged in side-by-side relation to each other,
wherein, the interfacial zone is disposed between the first continuous zone and the second continuous zone.

2. The die according to claim 1, wherein the shim comprises a metallic material.

3. The die according to claim 1, wherein the shim comprises a ceramic material.

4. (canceled)

5. The die according to claim 1, wherein the interfacial zone along the dispensing edge is configured to provide an extrudate comprised of a structured interface or a microstructured interface between the first and second molten polymeric materials.

6. An extrusion system for the manufacture of a multilayered film, comprising:
the extrusion die according to claim 1;
a source of first molten polymeric material connected to the extrusion die to feed the first molten polymeric material into the first die cavity;
a source of second molten polymeric material connected to the extrusion die to feed the second molten polymeric material into the second die cavity; and
cooling apparatus positioned to receive a multilayered molten sheet from the extrusion die, the multilayered molten sheet comprising the first and second molten polymeric materials, the cooling apparatus being at a temperature sufficient to at least partially solidify the multilayered molten sheet.

7. The extrusion system according to claim 6 wherein the source of first molten polymeric material is a first extruder and the source of second molten polymeric material is a second extruder, the first and second extruders being selected from single screw extruders and twin screw extruders.

8. The extrusion system according to claim 6 wherein the cooling apparatus comprises a chill roll.

9. The extrusion system according to claim 6 wherein the cooling apparatus comprises a series of cooling rolls.

10. The extrusion system according to claim 6 wherein the cooling apparatus comprises a water bath.

11. A method of producing an extruded article, the method comprising:
providing an extrusion system according to claim 1;
feeding the first molten polymeric material from the source of first molten polymeric material into the first die cavity and through the plurality of first extrusion channels, the first molten polymeric material comprising a layer of pressure sensitive adhesive material having first and second major surfaces;
extruding the second molten polymeric material from the source of second molten polymeric material through the second die cavity and through the second extrusion channels, the second molten polymeric material comprising a polymer release material having first and second major surfaces;
the pressure sensitive adhesive material and the polymer release material exiting the extrusion die through the first and second extrusion openings along the dispensing edge of the die to provide a multilayered extrudate wherein the first major surface of the pressure sensitive adhesive overlays the first major surface of the polymer release material, the multilayered extrudate having a structured interface between the pressure sensitive adhesive and the polymer release material; and
cooling the multilayered extrudate to provide the extruded article in the form of a pressure sensitive adhesive layer having a release liner removably affixed to the adhesive layer.

12. The method according to claim 11 further comprising adding a support layer to the second major surface of the pressure sensitive adhesive material.

13. The method according to claim 1 further comprising adding a support layer to the second major surface of the polymer release material.

14. The method according to claim 1, wherein cooling the multilayered extrudate comprises contacting the extrudate on a chill roll.

15. The method according to claim 1, wherein cooling the multilayered extrudate comprises contacting the extrudate on a series of cooling rolls.

16. The method according to claim 1, wherein cooling the multilayered extrudate comprises contacting the extrudate with a water bath.

17. The method according to claim 1, wherein the pressure sensitive adhesive is selected from the group consisting of acrylate, block copolymer, silicone and combinations thereof.

18. The method according to claim 17 wherein the block copolymer is a styrene-isoprene block copolymer.

19. The method according to claim 17 wherein the acrylate is the reaction product of acrylic acid and one or both of 2-ethylhexyl acrylate and isooctylacrylate.

20. The method according to claim 1, wherein the polymer release material is selected from the group consisting of polyolefin homo and copolymers, fluoropolymers, silicone polymers and combinations of two or more of the foregoing.

21. The method according to claim 20, wherein the polyolefin is selected from high density polyethylene, low density polyethylene, ultra-low density polyethylene and combinations thereof.

22. The method according to claim 20, wherein the polyolefin is selected from random or block copolymers of ethylene/propylene, ethylene/butene, ethylene/hexene, or ethylene/octene and combinations thereof.

23. An adhesive article made according to the method of claim 1.

24. An adhesive article, comprising:
an extruded pressure sensitive adhesive material layer having a first major surface and a second major surface, the second major surface having a microstructure provided by an extrusion die; and
an extruded release liner comprising a polymeric material layer having a first major surface and a second major surface, the first major surface of the release liner being releasably affixed to the second major surface of the pressure sensitive adhesive material and the first major surface of the release liner having a microstructure complimentary to the microstructure of the second major surface of the pressure sensitive adhesive material layer;
wherein, the microstructure on the first major surface of the extruded release liner will retain its microstructure when heated to the melting temperature of the first polymeric material.

25.-32. (canceled)
